(19) United States
(12) Patent Application Publication
(10) Pub. No.: US 2008/0227641 A1
(43) Pub. Date: Sep. 18, 2008

(54) Liquid compositions containing S-(+)-abscisic acid in combination with selected lipophilic agents and methods of their preparation

(76) Inventors: Daniel F. Heiman, Libertyville, IL (US); Bala Devisetty, Buffalo Grove, IL (US); Peter D. Petracek, Grayslake, IL (US); Xiaozhong Liu, Vernon Hills, IL (US); John Lopez, Gurnee, IL (US); Derek D. Woolard, Zion, IL (US); Yueh Wang, Arlington Heights, IL (US); Gregory D. Venburg, Deerfield, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/011,812

(22) Filed: Jan. 30, 2008

Related U.S. Application Data
(60) Provisional application No. 60/898,531, filed on Jan. 31, 2007.

(51) Int. Cl. A01N 37/06; A01P 21/00; A01P 1/00

(52) U.S. Cl. 504/320; 514/557

(57) ABSTRACT

The present invention generally relates to liquid compositions of S-(+)-abscisic acid containing selected lipophilic agents, and methods of their preparation for agricultural use.

### FIELD OF THE INVENTION

The present invention generally relates to S-(+)-abscisic acid and or its analogs in liquid compositions containing S-(+)-abscisic acid in combination with selected lipophilic agents to improve agrochemical performance as well as methods of their preparation.

### BACKGROUND OF THE INVENTION

Abscisic acid is a naturally occurring plant growth regulator which acts primarily to inhibit growth, maintain dormancy of buds, inhibit fruit-ripening, activate plant pathogen resistance response, induce senescence in already-damaged cells and their proximate neighbors, and help the plant tolerate stressful conditions. See Arteca, R. (1996), Plant Growth Substances: Principles and Applications. New York: Chapman & Hall; Mauseth, J. D. (1991), Botany: An Introduction to Plant Biology. Philadelphia: Saunders. pp. 348-415; Raven, P. H., Evert, R. F., and Eichhom, S. E. (1992), Biology of Plants. New York: Worth. pp. 545-572.

Abscisic acid owes its name to the belief that this plant growth regulator causes the abscission of leaves from deciduous trees in the fall. Absicin II and dormin are names previously used for this plant hormone. The chemistry and physiology of abscisic acid and its analogs is described by Milborrow, Ann. Rev. Plant Physiol. 1974, 25, 259-307.

The naturally occurring form of abscisic acid is S-(+)-abscisic acid. It has been reported that R-(−)-abscisic acid also has some biological activities. See, Zeevart J. A. D. and Creelman, R. A. (1988) Metabolism and Physiology of Abscisic Acid, Annu. Rev. Plant Physiol. Plant Mol. Biol. 39, 439-473. The side chain of naturally occurring abscisic acid is by definition 2-cis-,-4-trans. While prior art (U.K. Pat. No. 1251867) teaches, inter alia, amine salts of racemic abscisic acid, the prior art does not disclose salts of (S)-(+)-abscisic acid.

Abscisic acid was first identified as a growth inhibitor in the early 1960s, accumulating in abscising cotton fruit and leaves of sycamore trees photoperiodically induced to become dormant. See, Finkelstein R R, Rock C D (2002), Abscisic Acid Biosynthesis and Response, The Arabidopsis Book: Vol. 45, No. 1 pp. 1-48. Since then, abscisic acid has been shown to regulate many aspects of plant growth and development, including embryo maturation, seed dormancy, germination, cell division and elongation, etc. Although abscisic acid has historically been thought of as a growth inhibitor, young tissues have high abscisic acid levels, and abscisic acid-deficient mutant plants are severely stunted because their ability to reduce transpiration and establish turgor is impaired. Exogenous abscisic acid treatment of mutants restores normal cell expansion and growth.

Abscisic acid is thought to initiate its effects on cells through binding to receptor proteins, although their identities and locations are still largely unknown. Activation of the putative receptor(s) causes a chain of events that results in rapid changes in ion channels and slower changes in the pattern of gene transcription. While many individual components of this chain of events have been identified, a complete picture has not yet been obtained.

Commercial formulations comprising abscisic acid are used in agriculture for various purposes, such as improving stress tolerance, slowing the growth rate, adjusting flowering phase and other purposes. Abscisic acid has also been reported to possess insect inhibition qualities. See U.S. Pat. Nos. 4,434,180 and 4,209,530 to Visscher. Contents of these patents are herein incorporated by reference. Abscisic acid in a powdered form is currently commercially available from Lomon Biotechnology Company, Ltd., which markets it as a substance that, among other uses, improves the yield and quality of certain crops.

One of the problems associated with current abscisic acid formulations for use in agriculture is abscisic acid's relatively poor solubility in water: about 3 to 5 grams per liter or, alternatively, less than 0.5% by weight. A concentration of about 3000 parts per million (ppm) is the highest concentration that can be achieved in pure water at room temperature. Abscisic acid solubility in hard water is even less. While abscisic acid exhibits somewhat better solubility in some organic solvents, liquid formulations of abscisic acid in organic solvents are often undesirable due to flammability, toxicity, or pollution considerations.

Other major obstacles to efficacious and economical use of abscisic acid are cost, and its tendency to undergo sunlight induced chemical transformation into non-active forms. The latter in turn results in higher application rates than may otherwise be required, thus increasing cost. It is a purpose of this invention to improve the effectiveness of formulations of abscisic acid. Improved effectiveness in this context may imply either improved uptake, longer residual activity and/or reduced application rates.

For a foliar applied chemical, the rate of uptake depends on many factors including plant organ, species, and age, environmental conditions including temperature and humidity, method of application and composition of the applied solution. S-(+)-abscisic acid is an organic acid, with a water solubility approaching 3 grams/1000 mL water at 24° C. Conversely, the plant cuticle is a lipophilic membrane that covers the aerial parts of all terrestrial plants (Bukovac, M. J., 2005, Periodicum Biologorum, 107: 1-9; Bukovac, M. J. 2005, HortTechnology, 15: 222-231). Since the cuticle is the primary barrier to the penetration of foliar applied chemicals, agrochemical uptake is generally greatest for lipophilic compounds. One approach to increasing S-(+)-abscisic acid uptake and thus performance is by adding polarity-modifying agents to the formulation.

Thus it is an object of the present invention to increase the performance of S-(+)-abscisic acid though complexation with polarity modifying agents, which in turn affect the hydrophilic/hydrophobic character of the active ingredient.

Although discussions and examples presented herein refer to S-(+)-abscisic acid, it is well understood to anyone versed in the art, and is clearly intended by the inventors, to include racemic mixtures of abscisic acid.

### SUMMARY OF THE INVENTION

The present invention is generally directed to the concurrent administration, to the locus, soil, or seeds, of plants intended to benefit from such treatment, of S-(+)-abscisic acid and/or its analogs and salts thereof, in combination with surface active agents of basic (water solutions of said surface active agent(s) having pH>7) character and sufficient lipophilicity (HLB varying from 4 to 20).

Presently preferred ABA analogs and derivatives include PBI-429, PBI-524, PBI-696 and PBI-702.

For the purposes of this Application, abscisic acid analogs are defined by Structures 1, 2 and 3, wherein for Structure 1:

the bond at the 2-position of the side chain is a cis- or trans-double bond,

the bond at the 4-position of the side chain is a trans-double bond or a triple bond,

the stereochemistry of the alcoholic hydroxyl group is S-, R- or an R,S-mixture,

the stereochemistry of the R1 group is in a cis- relationship to the alcoholic hydroxyl group,

R1=ethynyl, ethenyl, cyclopropyl or trifluoromethyl, and
R2=hydrogen or lower alkyl

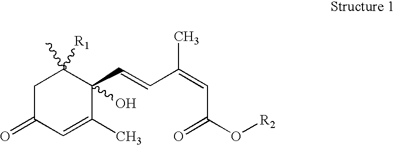

wherein lower alkyl is defined as an alkyl group containing 1 to 4 carbon atoms in a straight or branched chain, which may comprise zero or one ring or double bond when 3 or more carbon atoms are present.

For PBI-429, R1 is ethynyl and R2 is a methyl group.

For PBI-524, R1 is ethynyl and R2 is a hydrogen.

For PBI-696, R1 is cyclopropyl and R2 is a methyl group.

### For Structure 2:

the bond at the 2-position of the side chain is a cis- or trans-double bond,

the bond at the 4-position of the side chain is a triple bond,

the stereochemistry of the alcoholic hydroxyl group is S-, R- or an R,S-mixture, R1=hydrogen or lower alkyl

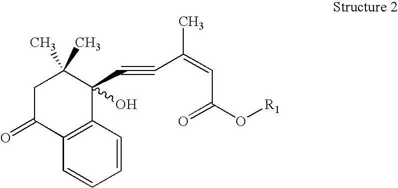

wherein lower alkyl is defined as an alkyl group containing 1 to 4 carbon atoms in a straight or branched chain, which may comprise zero or one ring or double bond when 3 or more carbon atoms are present.

For PBI-702, R1 is a methyl group.

### For Structure 3:

the bond at the 2-position of the side chain is a cis- or trans-double bond,

the bond at the 4-position of the side chain is a trans-double bond,

the stereochemistry of the alcoholic hydroxyl group is S-, R- or an R,S-mixture, R1=hydrogen or lower alkyl

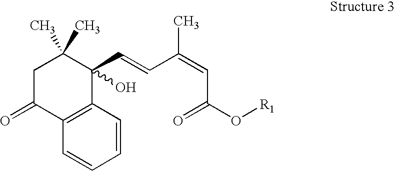

wherein lower alkyl is defined as an alkyl group containing 1 to 4 carbon atoms in a straight or branched chain, which may comprise zero or one ring or double bond when 3 or more carbon atoms are present.

In a further embodiment, the present invention is generally directed, but not limited to, aqueous compositions comprising an effective amount of S-(+)-abscisic acid or a analog, derivative or salt thereof and an effective amount of a surface active agent, wherein the equivalent concentration of the S-(+)-abscisic acid is at least about 0.0001% by weight of the aqueous composition, with the effective amount of the surface active agent varying from about 0.0001% to about 50% by weight of the aqueous composition.

Applicants have unexpectedly discovered that such compositions of S-(+)-abscisic acid or a analog, derivative or salt thereof, in the presence of a surface active agent possessing basic properties, allow for a dramatic decrease in plant transpiration. As a result of the present invention, aqueous (and non-aqueous) solutions can be obtained with S-(+)-abscisic acid equivalent concentrations as high as about 50% by weight, which can be diluted in water to S-(+)-abscisic acid equivalent concentrations as low as about 0.0001%, said water dilutions being highly effective in transpiration reduction.

The present invention allows for the creation of concentrated formulations of S-(+)-abscisic acid or analogs, derivatives or salts thereof which can be diluted prior to use to any intermediate dilution without risk of precipitation of the active ingredient.

Compositions of the present invention generally comprise S-(+)-abscisic acid or a analog, derivative or salt thereof, a basic surface active agent of sufficient hydrophobic properties (HLB may vary from 4 to 20) and an antimicrobial agent.

Representative surface-active agents include, but are not limited to, ethoxylated tallow amines, ethoxylated cocoamines, ethoxylated oleylamines, ethoxylated etheramines, ethoxylated alkyloxyalkylamines, ethoxylated alkyloxyalkylamines and polyamines. The degree of ethoxylation (moles EO) may vary widely.

In one embodiment, the surface-active agent is tallow amine substituted with 20 moles of ethoxylation (20EO). In another embodiment, the surface-active agent is ethoxylated 14C alkyloxypropylamine with five moles of ethoxylation (5EO). In yet another embodiment, the surface active agent is ethoxylated 17C alkyloxypropyl-1,3-diaminopropane with five moles of ethoxylation (5EO). Surface-active agents are not limited to the above-mentioned surfactants as others may also be suitable for use in the present invention.

The present invention is also directed to methods of preparation of compositions comprising S-(+)-abscisic acid or analogs, derivatives or salts thereof in solutions with said surface active agents possessing basic properties.

In one embodiment, the invention is directed to a method of preparation of a S-(+)-abscisic acid formulation comprising S-(+)-abscisic acid in solution with tallow amine, the latter being substituted with 20 moles of ethoxylation (20EO).

In another embodiment, the invention is directed to a method of preparation of S-(+)-abscisic acid formulation comprising S-(+)-abscisic acid in solution with ethoxylated 14C alkyloxypropylamine substituted with five moles of ethoxylation (5EO).

In yet another embodiment, the invention is directed to a method of preparation of S-(+)-abscisic acid formulation comprising S-(+)-abscisic acid in solution with ethoxylated 17C alkyloxypropyl-1,3-diaminopropane with five moles of ethoxylation (5EO).

The disclosed embodiments are simply exemplary embodiments of the inventive concepts disclosed herein and should not be considered as limiting, unless the claims expressly state otherwise.

### DETAILED DESCRIPTION OF THE INVENTION

The present invention relates to liquid, compositions of (S)-(+)-abscisic acid. Abscisic acid is an optically active 15-C weak acid. The structural formula of abscisic acid is set forth below:

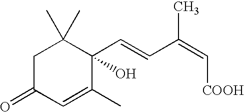

The liquid compositions of the present invention utilize the S-(+) enantiomer rather than a racemic mixture of stereoisomers. Unless expressly stated otherwise, in all instances when the Application refers to abscisic acid, it refers to S-(+)-abscisic acid.

In one aspect, the present invention relates to an aqueous composition for the treatment of plants comprising an effective amount of S-(+)-abscisic acid, wherein the equivalent concentration of S-(+)-abscisic acid is at least 0.0001% by weight of said composition. The compositions of this invention also contain one or more surface-active agent(s) possessing basic (water solutions of said surface-active agent(s) having pH>7) character and sufficient lipophilicity (HLB may vary from 4 to 20), in amount(s) from 0.0001% to about 50% by weight of the composition, sufficient to affect the enhanced biological activity observed and claimed herein.

As used herein, all numerical values relating to amounts, weight percentages and the like, are defined as “about” or “approximately” each particular value, namely, plus or minus 10%. For example, the phrase “at least 5% by weight” is to be understood as “at least 4.5% to 5.5% by weight.” Therefore, amounts within 10% of the claimed values are encompassed by the scope of the claims.

The phrase “effective amount” of S-(+)-abscisic acid means a sufficient amount of S-(+)-abscisic acid to provide the desired effect. The amount of S-(+)-abscisic acid that is “effective” will vary from composition to composition, depending on the particular agricultural use, the particular composition or compositions, and the like. Thus, it is not always possible to specify an exact “effective amount.” However, an appropriate “effective amount” in any individual case may be determined by one of ordinary skill in the art using routine experimentation.

The phrase “sufficient lipophilicity” and or “sufficient amount” of surface active agent(s) means sufficient lipophilicity and/or sufficient amount of the surface active agent to provide the desired effect. The amount of the surface active agent and/or the degree of lipophilicity that is “effective” and/or “sufficient” will vary from composition to composition, depending on the particular agricultural use, the particular composition or compositions, and the like. Thus, it is not always possible to specify an exact “effective amount” or exact “sufficient” or “effective” lipophilicity. However, an appropriate “effective amount” or “sufficient” or “effective” lipophilicity in any individual case may be determined by one of skilled in the art, using routine experimentation.

Liquid compositions of the present invention can be prepared as either ready-to-use dilutions or dilutable concentrates. According to the present invention, a solution containing from about 0.0001% to as much as about 50% of abscisic acid by weight of the composition can be obtained. The dilutable concentrates can be diluted directly to a final application concentration or to any intermediate dilution, without risk of precipitation of the active ingredient. Aqueous formulations according to the present invention are inexpensive to manufacture, stable under storage and shipping conditions, and are safe to handle and use. A person skilled in the art would be able to determine how to prepare the dilutions without undue experimentation.

The end user can use compositions of the present invention for various purposes, such as improving stress tolerance, slowing the growth rate, adjusting flowering phase, seed treatment, inhibiting the growth of stalk leaf, preventing preharvest fruit and flower drop and improving the quality and color of fruits. Possible uses may also include, for example, distribution and sale of various concentrated solutions of (S)-(+)-abscisic acid. Utilizing such high concentrations for shipping and handling allows the use of smaller volumes of water, thus simplifying shipping and handling procedures and decreasing costs. The end user could then dilute the product to a 2% concentration (or other percentage depending on the end user's needs) and fill the supply bottle of mixing equipment for spray or drench application to ornamental bedding plants ready for shipment. Alternatively, another end user could prepare a diluted solution for injection into the drip irrigation system for a vineyard at the appropriate time to enhance the color or phenolic content of a wine grape crop.

Surfactants that may be employed in the compositions of the present invention are of basic (water solutions of said surface active agent(s) having pH>7) character and have sufficient lipophilicity (HLB varying from 4 to 20). Representative such surfactants include, but are not limited to, ethoxylated 17C alkyloxypropyl-1,3-diaminopropane with 3-20 moles of ethoxylation (3-20EO), ethoxylated 14C alkyloxypropylamine substituted with 3-20 moles of ethoxylation (3-20EO), tallow amine, the latter being substituted with 3-40 moles of ethoxylation (3-40EO), and other similar compounds.

In another aspect, the present invention relates to methods of preparation of the compositions of S-(+)-abscisic acid of this invention. For example, in one embodiment, the invention is directed to a method of preparation of an abscisic acid formulation comprising the combination of S-(+)-abscisic acid with tallow amine (20EO). In another embodiment, the invention is directed to a method of preparation of abscisic acid formulations comprising the combination of S-(+)-abscisic acid with a 14C alkyloxypropylamine substituted with 5 moles of ethoxylation (5). In yet another embodiment, the invention is directed to a method of preparation of the organic amine salt comprising reacting S-(+)-abscisic acid with ethoxylated 17C alkyloxypropyl-1,3-diaminopropane with 5 moles of ethoxylation (5EO).

In a preferred embodiment, the aqueous solution comprises an antimicrobial agent to prevent microbial growth during long-term storage. The presently most preferred antimicrobial agent is potassium sorbate. In a more preferred embodiment, the pH of the solution at use dilution is approximately neutral (pH=7+/−1).

Preferred compositions of the present invention comprise from 0.0001 to 50 weight % of S-(+)-abscisic acid, from about 0.0001 to about 50 weight % of a surfactant, from about 0.1 to about 10 weight % of an antimicrobial agent and the balance is water.

The following examples are intended to illustrate the present invention and to teach one skilled in the art how to make and use the invention. They are not intended to limit the invention or its protection in any way.

### EXAMPLE 1

### Preparation of (S)-(+)-abscisic Acid in Combination with Tallow Amine Substituted with 20 Moles of Ethoxylation (20EO)

Abscisic acid (90% pure), 5.5 g, was suspended in 30.0 g water with magnetic stirring. Tallow amine substituted with 20 moles of ethoxylation (20EO), 11.0 g., was then added to the suspension, followed by 0.1 g of potassium sorbate, and the mixture stirred until a complete dissolution of all components. More water was then added, bringing the total weight to 50.0 g.

The formulation contains an equivalent 10% abscisic acid preparation by weight, which can be stored for over a year without loss of abscisic acid content.

### EXAMPLE 2

### Preparation of (S)-(+)-abscisic Acid in Combination with 14C Alkyloxypropylamine Substituted with 5 moles of Ethoxylation (5EO)

Abscisic acid (90% pure), 5.5 g, was suspended in 30.0 g water with magnetic stirring. 14C alkyloxypropylamine substituted with 5 moles of ethoxylation (5EO), 6.5 g., was then added to the suspension, followed by 0.1 g of potassium sorbate, and the mixture stirred until a complete dissolution of all components. More water was then added, bringing the total weight to 50.0 g.

The formulation contains an equivalent 10% abscisic acid preparation by weight, which can be stored for over a year without loss of abscisic acid content.

### EXAMPLE 3

### Preparation of (S)-(+)-abscisic Acid in Combination with 17C Alkyloxypropylamine Substituted with 5 Moles of Ethoxylation (5EO)

Abscisic acid (90% pure), 5.5 g, was suspended in 30.0 g water with magnetic stirring. 17C alkyloxypropylamine substituted with 5 moles of ethoxylation (5EO), 7.7 g., was then added to the suspension, followed by 0.1 g of potassium sorbate, and the mixture stirred until a complete dissolution of all components. More water was then added, bringing the total weight to 50.0 g.

The formulation contains an equivalent 10% abscisic acid preparation by weight, which can be stored for over a year without loss of abscisic acid content.

### EXAMPLE 4

### Preparation of (S)-(+)-abscisic Acid in Combination with 17C Alkyloxypropyl-1,3-diaminopropane with Three Moles of Ethoxylation (3EO)

Abscisic acid (90% pure), 5.5 g, was suspended in 30.0 g water with magnetic stirring. 17C alkyloxypropyl-1,3-diaminopropane with three moles of ethoxylation (3EO), 6.5 g. was then added to the suspension, followed by 0.1 g of potassium sorbate, and the mixture stirred until a complete dissolution of all components. More water was then added, bringing the total weight to 50.0 g.

The formulation contains an equivalent 10% abscisic acid preparation by weight, which can be stored for over a year, without loss of abscisic acid content.

### EXAMPLE 5

### Preparation of an Aqueous Solution Composition of the Ammonium Salt of (S)-(+)-abscisic Acid Comprising Potassium Sorbate

In a 600 mL beaker, 55 g of (S)-(+)-abscisic acid of 95% purity was added, followed by 500 μL of Tween 20 and 200 mL of water. Then, 10 mL of concentrated aqueous ammonia were added while stirring until the mixture came to equilibrium. Then, additional concentrated ammonia was added drop-wise until all solid was dissolved. A homogenous solution was achieved when a total of about 13.5 mL of ammonia has been added. At this point, potassium sorbate (1.25 g) was added to the composition; it quickly dissolved. The mixture was transferred to a 500 ml volumetric flask and was brought up to 500 mL with de-ionized water. The mixture was stored in a brown glass bottle. The pH was measured to be 6.50.

The formulation comprises 10% abscisic acid as the ammonium salt by weight and a naturally-occurring antimicrobial preservative.

### EXAMPLE 6

### Efficacy of (S)-(+)-abscisic Acid in Combination with Tallow Amine Substituted with 20 Moles of Ethoxylation (20EO)

Seedlings of Rutgers Tomato were sprayed with 4 ml water or treatment solution at the 3-4 leaf stage and held under well watered conditions in a greenhouse. Transpiration was measured daily for 3 days after treatment with a LiCor 1600 porometer. Transpiration readings were converted to percent of control to compensate for daily differences due to environmental factors like light intensity, humidity, and temperature.

TABLE 1
Effects of ABA ammonium salt and BAB-0230-47-4 on
transpiration rate of Rutgers tomato seedlings as
% of the transpiration rate of control plants.

| | 1 day | 2 days | 3 days | Average of days |
|---|---|---|---|---|
| | after | after | after | 1, 2, and |
| Treatments | treatment | treatment | treatment | 3 after treatment |
| Water | 100* | 100 | 100 | 100 |
| 75 ppm ABA | 91 | 94 | 72 | 86 |
| 250 ppm ABA | 72 | 102 | 75 | 83 |
| 750 ppm ABA | 60 | 83 | 68 | 70 |
| 2500 ppm ABA | 36 | 35 | 43 | 38 |
| 75 ppm BAB- | 33 | 65 | 60 | 53 |
| 0230-74 | | | | |

*Transpiration rate as a percentage of the transpiration rate of control plants.

Spraying Rutgers tomato seedlings with ABA reduced transpiration in a dose dependant manner. Spraying Rutgers tomato seedlings with 75 ppm (S)-(+)-abscisic acid in combination with tallow amine substituted with 20 moles of ethoxylation (BAB-0230-47-4) was more effective than treating the seedlings with 750 ppm ABA ammonium salt (VBC-30074).

TABLE 2
Relative Suppression Effect of Selective S-(+)-ABA
Formulations on Rutgers Tomato

| | Equivalent to s-ABA (ppm) | | (Regression) |
|---|---|---|---|
| | ABA | | Calculated |
| Treatments | (ppm) | Log [ABA] | Enhancement |
| 100 ppm ABA | 100 | 2.00 | 1.00 |
| 100 ppm BAB-0230-47-2 | 367.0 | 2.56 | 3.67 |
| 100 ppm BAB-0294-5 | 199.4 | 2.30 | 1.99 |
| 100 ppm BAB-0294-6 | 801.1 | 2.90 | 8.01 |
| 100 ppm BAB-0294-7 | 540.2 | 2.73 | 5.40 |

1. An aqueous composition the comprising an effective amount of S-(+)-abscisic acid or a analog, derivative or salt thereof, in combination with one or more surface-active agent(s) possessing basic character and sufficient lipophilicity, in amount(s) from 0.0001% to 50% by weight of the composition and an effective amount of an antimicrobial agent.

2. The aqueous composition of claim 1, wherein said surface active agent is selected from the group consisting of tallow amine, oleylamine, alkoxyalkylamine, alkoxyalkylpolyamine and cocoamine, substituted with 5-40 moles of ethoxylation (5-40EO).

3. The aqueous composition of claim 1, wherein said surface active agent is tallow amine substituted with 5 moles of ethoxylation (5EO).

4. The aqueous composition of claim 1, wherein said surface active agent is tallow amine substituted with 10 moles of ethoxylation (10EO).

5. The aqueous composition of claim 1, wherein said surface active agent is tallow amine substituted with 15 moles of ethoxylation (15EO).

6. The aqueous composition of claim 1, wherein said surface active agent is tallow amine substituted with 20 moles of ethoxylation (20EO).

7. The aqueous composition of claim 1, wherein said surface active agent is 14C alkyloxypropylamine substituted with 2 moles of ethoxylation (2EO).

8. The aqueous composition of claim 1, wherein said surface active agent is 14C alkyloxypropylamine substituted with 5 moles of ethoxylation (5EO).

9. The aqueous composition of claim 1, wherein said surface active agent is 17C alkyloxypropylamine substituted with 2 moles of ethoxylation (2EO).

10. The aqueous composition of claim 1, wherein said surface active agent is 17C alkyloxypropylamine substituted with five moles of ethoxylation (5EO).

11. The aqueous composition of claim 1, wherein said surface active agent is 17C alkyloxypropyl-1,3-diaminopropane with three moles of ethoxylation (3EO).

12. The aqueous composition of claim 1, wherein said antimicrobial agent is potassium sorbate.

13. The composition of claim 1, wherein the concentration of S-(+)-abscisic acid is at least 0.0001% by weight of said composition.
